(19) United States
(12) Patent Application Publication
(10) Pub. No.: US 2010/0024775 A1
(43) Pub. Date: Feb. 4, 2010

(54) Fuel supply apparatus

(75) Inventors: Junichiro Takahashi, Odawara-shi (JP); Hirokazu Hirosawa, Odawara-shi (JP); Yuichi Baba, Odawara-shi (JP)

Correspondence Address: STAAS & HALSEY LLP, SUITE 700, 1201 NEW YORK AVENUE, N.W., WASHINGTON, DC, 20005, US

(73) Assignee: MIKUNI CORPORATION, Tokyo (JP)

(21) Appl. No.: 12/461,022

(22) Filed: Jul. 29, 2009

(30) Foreign Application Priority Data
Jul. 30, 2008 (JP) 2008-195653

(51) Int. Cl. F02M 61/14; F02M 61/00

(52) U.S. Cl. 123/470; 123/445

(57) ABSTRACT

A fuel supply apparatus having a fuel tank, throttle body, and fuel injection device configured integrally. The fuel injection device is positioned between the fuel tank and throttle body. The fuel injection device is a pressure-type fuel injection device that injects the fuel by pumping the fuel by reciprocative movement of a plunger. The fuel injection device injects the fuel located in the fuel tank into the intake passage of the throttle body on the basis of a signal from an Electronic Control Unit (ECU).

### CROSS-REFERENCE TO RELATED APPLICATIONS

This application claims the benefit of Japanese Application No. 2008-195653, filed Jul. 30, 2008, in the Japanese Intellectual Property Office, the disclosure of which is incorporated herein by reference.

### BACKGROUND

1. Field

The present invention relates to a fuel supply apparatus having a fuel tank, a throttle body, and a fuel injection device.

2. Description of the Related Art

Conventional fuel supply apparatuses in which fuel stored in a fuel tank is injected by a fuel injection device into an intake passage of a throttle body or an intake passage communicating with the throttle body and supplied to an engine are described, for example, in Japanese Patent Application Laid-open Nos. 2000-238680 and H11-303702 and Japanese Patent No. 3896997.

Thus, in the configuration described in Japanese Patent Application Laid-open No. 2000-238680, a fuel injector is provided integrally with a throttle body, a fuel pump that pumps the fuel located in a fuel tank into the fuel injector is provided separately, the fuel pump is integrally attached to the throttle body, and the fuel is pumped from the fuel pump to the fuel injection valve via a high-pressure hose.

In the configuration described in Japanese Patent Application Laid-open No. H11-303702, a fuel chamber cylinder is provided parallel to an air passage of a throttle body at one side of the throttle body, a fuel pump is accommodated in a fuel chamber formed inside the fuel chamber cylinder, and a fuel injection valve is provided integrally with the throttle body on the side opposite that of the fuel pump. The fuel pressurized by the fuel pump is supplied to a fuel distributor, and the fuel is injected from the fuel distributor via the fuel injection valve into the air passage of the throttle body.

Japanese Patent No. 3896997 describes a fuel injection device in which a fuel pump and a fuel injection valve are configured integrally. Specifically, a fuel injection device is described in which the fuel located in a fuel tank is pressurized by a fuel pump and the pressurized fuel is injection supplied toward the engine via a fuel injection valve, wherein the fuel pump, the fuel injection valve, a pressure regulator, and a pulsation damper are integrally attached to a base body, and the base body provided with the fuel pump and fuel injection valve is attached to an intake tube. An injection port of the fuel injection valve is opened in the intake passage of the intake tube, and the intake passage of the intake tube communicates with an intake passage of the throttle body.

In the configuration described in Japanese Patent Application Laid-open No. 2000-238680, the fuel pump is integrally attached to the throttle body, and because the fuel pump and fuel injector are configured separately from each other, the fuel is supplied from the fuel pump to the fuel injector via a high-pressure hose. As a result, the length of the high-pressure hose can be decreased, but the high-pressure hose cannot be completely eliminated. Further, because the fuel pump and fuel tank are provided separately from each other, the length of pipe therebetween increases and an installation area required therefor in a vehicle body expands, thereby placing limitation on possible arrangement layout.

In the configuration described in Japanese Patent Application Laid-open No. H11-303702, the fuel pump and fuel injection valve are disposed on both sides of the throttle body. Therefore, a high-pressure pipe that leads from the fuel pump to the fuel injection valve is necessary. Further, because the fuel pump and fuel tank are provided separately from each other, the length of pipe therebetween increases and a limitation is placed on possible arrangement layout, in the same manner as in Japanese Patent Application Laid-open No. 2000-238680.

The configuration described in Japanese Patent No. 3896997 uses a fuel injection apparatus in which the fuel pump and fuel injection valve are configured integrally. Therefore, a high-pressure pipe leading from the fuel pump to the fuel injection valve can be eliminated. However, because the fuel pump and fuel tank are provided separately from each other, the length of pipe therebetween increases and a limitation is placed on possible arrangement layout, in the same manner as in Japanese Patent Application Laid-open No. 2000-238680.

### SUMMARY

In view of the foregoing, it is an aspect of the present invention to provide a fuel supply apparatus in which a high-pressure pipe can be eliminated, the pipes between the fuel tank, throttle body, and fuel injection device can be shortened, and the degree of freedom in selecting an arrangement layout can be increased.

Additional aspects of the invention will be set forth in part in the description which follows and, in part, will be apparent from the description, or may be learned by practice of the embodiments of the invention.

In order to attain the aforementioned aspect, a fuel supply apparatus includes a fuel tank, a throttle body, and a fuel injection device that injects fuel located in the fuel tank into an intake passage of the throttle body, wherein the fuel tank, throttle body, and fuel injection device are provided integrally.

According to an aspect, the fuel tank, throttle body, and fuel injection device are provided integrally. As a result, these components are unitized. Therefore, a high-pressure pipe can be eliminated, a compact structure is obtained, and distance between these three components is shortened. As a result, the length of the fuel pipe can be shortened. Further, because the fuel tank, throttle body, and fuel injection device are provided integrally and unitized, the degree of freedom of layout when the components are disposed on the attachment object such as a motorcycle body can be increased. In addition, because the three components are unitized, the number of attachment locations can be reduced. Therefore, the occurrence of fuel leak caused by poor attachment is prevented. In addition, because the number of parts and attachment locations is decreased, the production cost can be reduced.

The fuel injection device may be positioned between the fuel tank and the throttle body.

The fuel injection device may be positioned between the fuel tank and the throttle body. Therefore, by disposing the fuel tank at the top, it is possible to ensure uninhibited fuel supply even when the disposition location of the attachment object such as a motorcycle body is inclined.

A fuel pump and a fuel injection valve may be configured integrally in the fuel injection device for advantageously integrating the fuel injection device with the fuel tank and throttle body.

The fuel injection device may be a pressure-type fuel injection device that injects the fuel by pumping the fuel by reciprocative movement of a plunger for advantageously integrating the fuel injection device with the fuel tank and throttle body.

In the fuel supply apparatus in accordance with the present invention, the fuel tank, throttle body, and fuel injection device are provided integrally and unitized. Therefore, a high-pressure pipe can be eliminated and a compact structure is obtained. As a consequence, the length of the fuel pipe can be shortened. Further, the degree of freedom of layout when the components are disposed on the attachment object such as a motorcycle body can be increased. In addition, because the three components are unitized, the number of attachment locations can be reduced, the occurrence of fuel leak caused by poor attachment can be prevented, and the production cost can be reduced.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a front view illustrating the fuel supply apparatus of an embodiment;

FIG. 2 is a left side view of the fuel supply apparatus of an embodiment;

FIG. 3 is a rear view of the fuel supply apparatus of an embodiment; and

FIG. 4 is a sectional view along the A-A line in FIG. 1 that shows schematically the inside of the fuel injection device.

### DETAILED DESCRIPTION OF EMBODIMENTS

Reference will now be made in detail to an embodiment of the present invention, examples of which are illustrated in the accompanying drawings, wherein like reference numerals refer to the like elements throughout.

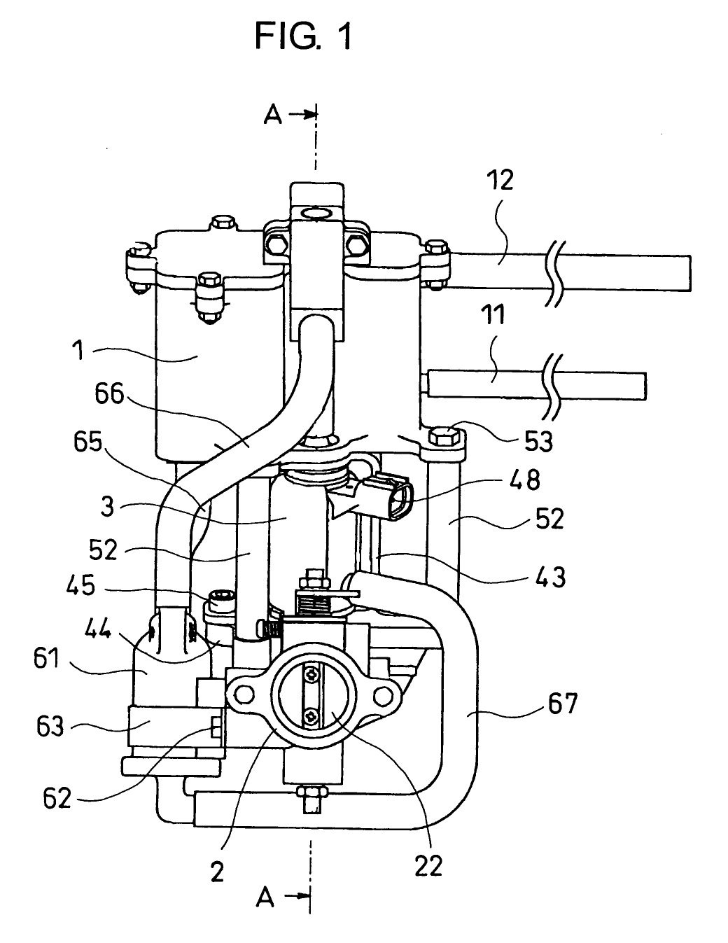

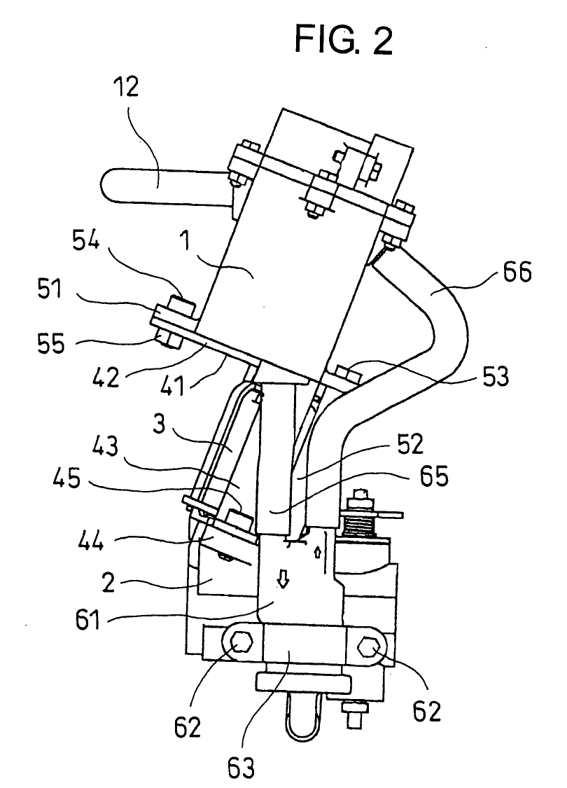

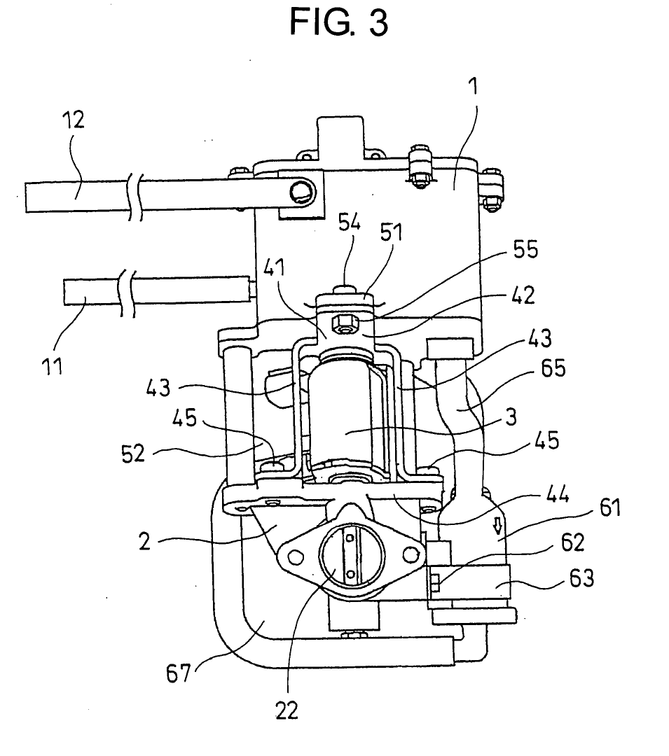

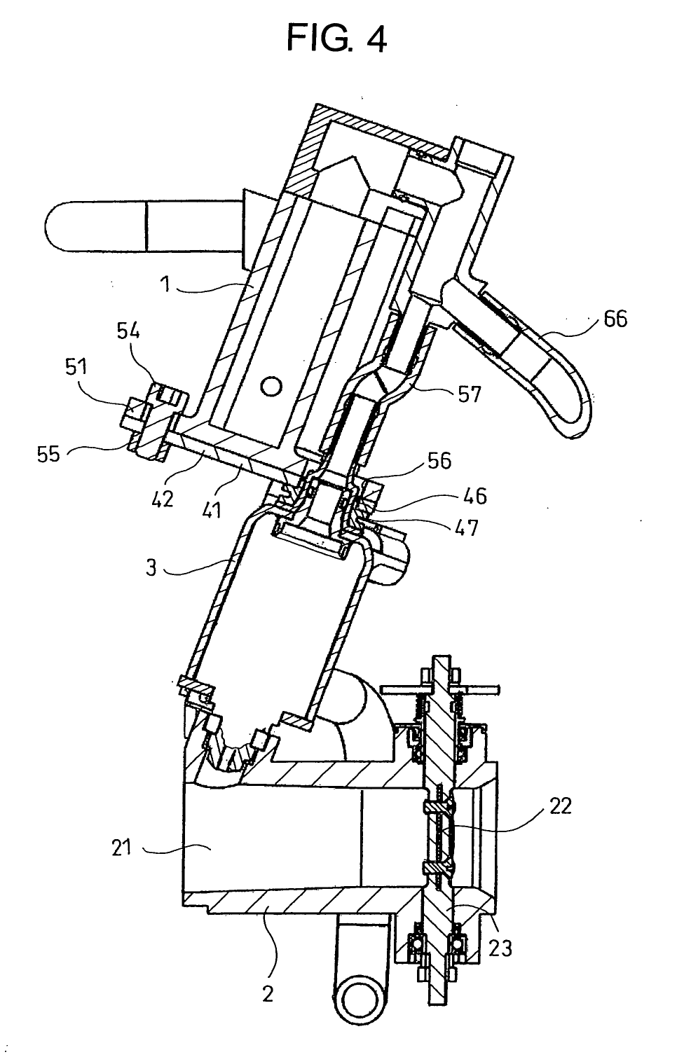

FIGS. 1 to 4 show a fuel supply apparatus of an embodiment of the present invention. FIG. 1 is a front view, FIG. 2 is a left side view, FIG. 3 is a rear view, and FIG. 4 is a sectional view along the A-A line in FIG. 1. In FIG. 4, the inside of the fuel injection apparatus is shown schematically.

In the fuel feed apparatus, a fuel tank 1, a throttle body 2, and a fuel injection device 3 are integrally configured. The fuel tank 1 is a sub-tank that is connected to a main tank (not shown in the figure) by pipes 11 and 12. In a straight intake passage 21 of the throttle body 2, a throttle valve 22 is provided in the end portion of the upstream side of the intake passage 21. The throttle valve 22 is fixed to a throttle shaft 23 that is rotatably supported by the throttle body 2, and the throttle valve can open and close the intake passage, following the rotation of the throttle shaft 23. The upstream side of the intake passage 21 of the throttle body 2 is connected to an air cleaner, and the downstream side of the intake passage is connected to an engine. A fuel injection device 3 is a pressure-type fuel injection device that injects the fuel by pumping the fuel by reciprocative movement of the plunger. The fuel located in the fuel tank 1 is injected into the intake passage 21 of the throttle body 2 on the basis of a signal from an Electronic Control Unit (ECU). In such a fuel injection device 3, an electromagnetically driven plunger pump and an injection nozzle are configured integrally as described, for example, in Japanese Patent Application Laid-open No. 2007-263016.

In the fuel injection device 3, an end portion on the injection nozzle side is inserted in and fixed to an end portion of the downstream side of the intake passage 21 of the throttle body 2. The fuel injection device 3 is attached obliquely at a predetermined angle to the intake passage 21 of the throttle body 2, and the injection nozzle of the fuel injection device injects the fuel into the intake passage 21 at a predetermined angle to the intake passage 21.

The end portion of the fuel injection device 3 at the plunger pump side is fixed to a plate-shaped bracket 41 attached to the throttle body 2. Thus, the bracket 41 is obtained by integrally forming a stripe-like inclined portion 42 and a pair of plate-like leg portions 43, 43 that extend with a certain spacing therebetween from both ends of the inclined portion 42 so as to be substantially perpendicular to the inclined portion 42. A flange 44 that protrudes at both sides from the throttle body 2 in the direction perpendicular to the extension direction of the intake passage 21 and fuel injection device 3 is formed integrally with the throttle body 2 at the end portion on the downstream side of the intake passage 21 of the throttle body 2. One end of each leg portion 43, 43 of the bracket 41 is fixed by screws 45, 45 to the flange 44. The leg portions 43, 43 of the bracket 41 extend along the fuel injection device 3 at a certain small distance from the outer periphery of the fuel injection device 3. The end portion of the fuel injection device 3 on the plunger pump side is inserted into a through hole 46 of the inclined portion 42 that is formed integrally with other end portions of the leg portions 43, 43, and the end portion of the fuel injection device 3 on the plunger pump side is supported by the bracket 41 by introducing a grommet 47 between this end portion and the through hole 46 of the inclined portion 42.

Further, a connector 48 for electric connection is provided at the end portion of the fuel injection device 3 on the plunger pump side, and the fuel injection device 3 is electronically controlled based on signals from the ECU.

The fuel tank 1 is disposed opposite the throttle body 2, the fuel injection device 3 being interposed therebetween, and fixed to the throttle body 2 and bracket 41.

Thus, a plate-like attachment portion 51 is provided at the bottom portion of the fuel tank 1, a fine and long cylindrical collar 52 is inserted between the attachment portion 51 and the flange 44 of the throttle body 2, a bolt 53 is inserted into a through hole of the attachment portion 53 and the collar 52, and the distal end of the bolt 52 is screwed in a thread formed in the flange 44, thereby fixing the fuel tank 1 to the throttle body 2. In this example, two bolts 53 (and collars 52) are used.

The attachment portion 51 and the inclined portion 42 of the bracket 41 are fixed by a bolt 54 and a bolt 55.

The end portion of the fuel injection device 3 on the plunger pump side is inserted in the through hole 56 of the attachment portion 51, a return pipe 57 is provided between this end portion and the fuel tank 1, and fuel and vapors are returned from the fuel injection device 3 into the fuel tank 1 via this return pipe 57.

A fuel filter 61 is mounted on and clamped to the side surface of the throttle body 2 with a plate-shaped clamp 63 that is fixed by a screw 62 to the throttle body 2. A fuel supply pipe 65 and an air drain pipe 66 are provided between the fuel filter 61 and the fuel tank 1, and a fuel supply pipe 67 is provided between the fuel filter 61 and the fuel injection device 3.

Such a fuel supply apparatus in which the fuel tank 1, throttle body 2, and fuel injection device 3 are configured integrally and unitized is mounted, with the fuel tank 1 facing upward, on an attachment object such as a motorcycle body. As a result, the fuel tank 1 is positioned above the fuel injection device 3, and the fuel injection device 3 is positioned above the throttle body 2. Further, the fuel located in the fuel tank 1 is supplied to the fuel injection device 3 via the fuel supply pipe 65, fuel filter 61, and fuel supply pipe 67, and the fuel is injected from the fuel injection device 3 into the intake passage 21 of the throttle body 2.

In such a fuel supply apparatus, because the fuel tank 1, throttle body 2, and fuel injection device 3 are configured integrally and unitized, a high-pressure pipe can be eliminated, a compact structure is obtained, and the distance between these three components is shortened. Therefore, the length of pipes 57, 65, 66, and 67 can be decreased.

Further, because the fuel tank 1, throttle body 2, and fuel injection device 3 are configured integrally and unitized, when the fuel supply apparatus is disposed on the attachment object such as a motorcycle body, the apparatus can be disposed in a narrow space and the degree of freedom in designing a layout is increased.

Because the fuel tank 1, throttle body 2, and fuel injection device 3 are integrated, the number of attachment locations is reduced. Therefore, the occurrence of fuel leak caused by poor attachment is prevented. In addition, because the number of parts and attachment locations is decreased, the production cost can be reduced.

Moreover, because the fuel injection device 3 is positioned between the fuel tank 1 and the throttle body 2, by disposing the fuel tank 1 at the top, it is possible to ensure uninhibited fuel supply even when the disposition location of the attachment object such as a motorcycle body is inclined, and this feature further increases the degree of freedom in designing a layout.

In the above-described embodiment, the fuel injection device 3 is used in which the plunger pump and injection nozzle are integrally configured, but this configuration of the fuel injection device is not limited and a device can be used in which the fuel pump and fuel injection valve are integrally configured, as described, for example, in Japanese Patent No. 3896997.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A fuel supply apparatus comprising:
a fuel tank;
a throttle body; and
a fuel injection device that injects fuel located in the fuel tank into an intake passage of the throttle body,
wherein the fuel tank, the throttle body, and the fuel injection device are provided integrally.

2. The fuel supply apparatus according to claim 1, wherein the fuel injection device is positioned between the fuel tank and the throttle body.

3. The fuel supply apparatus according to claim 2, wherein the fuel injection device includes a fuel pump and a fuel injection valve that are configured integrally in the fuel injection device.

4. The fuel supply apparatus according to claim 2, wherein the fuel injection device includes a plunger and the fuel injection device injects the fuel by pumping the fuel by reciprocative movement of the plunger.

5. The fuel supply apparatus according to claim 1, further comprising:
an attachment portion in the form of a plate provided at a bottom portion of the fuel tank;
a flange formed on the throttle body;
a cylindrical collar inserted between the attachment portion and the flange of the throttle body; and
a bolt connecting the attachment portion, collar and fuel tank.
